(19) United States
(12) Patent Application Publication
(10) Pub. No.: US 2025/0139248 A1
(43) Pub. Date: May 1, 2025

(54) UNIVERSAL BOOT INTERFACE

(71) Applicant: Nvidia Corporation, Santa Clara, CA (US)

(72) Inventor: Varun Sampath, Santa Clara, CA (US)

(21) Appl. No.: 18/800,514

(22) Filed: Aug. 12, 2024

Related U.S. Application Data
(60) Provisional application No. 63/545,809, filed on Oct. 26, 2023.

(51) Int. Cl. G06F 21/57; G06F 9/4401

(52) U.S. Cl. CPC G06F 21/575; G06F 9/4401; G06F 2221/034

(57) ABSTRACT

Systems and methods herein are for an interface that may be associated with a system-on- chip (SoC) manager and a root of trust (RoT) module and can receive boot media parameters of connected and expected devices. The interface may also initiate First Mutable Code (FMC) fetches which may be loaded to the RoT module and may enforce a boot policy that may require acknowledgement and approval of at least the SoC manager and the RoT module to continue a boot process.

### CROSS-REFERENCE TO RELATED APPLICATION

This Non-Provisional Application claims the benefit of priority to U.S. Provisional Application No. 63/545,809 titled “UNIVERSAL BOOT INTERFACE,” filed on Oct. 26, 2023, the entire contents of which is incorporated by reference herein for all intents and purposes.

### TECHNICAL FIELD

At least one embodiment pertains to system-on-chip (SoC) having ability for Root of Trust (RoT) measurement and authentication to address possible compromise in a boot process.

### BACKGROUND

A root of trust (RoT) may represent a set of functions that may be fully and always trusted by an operating system (OS) of a computer system. As a result, the RoT may enable secure operations in the computer system. The RoT may include keys that may be used for operations, including for digital signing, digital verification, and cryptography. With at least this ability, the RoT can also enable a secure boot process using a chain of trust. The chain of trust may be to ensure that a boot process occurs with legitimate code. When a piece of code is to be executed, it may need to be verified as legitimate code. The chain of trust enables credentials that can be trusted to enable the execution of the code and every subsequent pieces of code. The RoT may also be used with a system-on-chip (SoC) hardware and firmware as a security feature that includes the aforementioned keys. The keys can be used for cryptography of verified code in the secure boot process. For example, a measured boot process may enable a system to determine a firmware and a configuration of a computer system as it progresses through a boot process. While there may be proprietary flows for fetching a respective first mutable code (FMC) from a boot media, the fetching process may be disrupted or compromised due to security issuses or manageability issues at the RoT. In one example, security issues of a boot process may be associated with a need to trust a RoT for Measurement (RTM) and a RoT for Verification (RTV) features in the boot process. A compromise or vulnerability can also compromise subsequent and important boot processes. Further, in an example of the manageability issues, elimination of flash memory for flashless boot and reduction in package pad count are both features that may cause additional challenges to implementation of the RoT.

### BRIEF DESCRIPTION OF DRAWINGS

FIG. 1 illustrates a system that is subject to embodiments of an interface for a system- on-chip with a Root of Trust module to address possible compromise in a boot process;

FIG. 2 illustrates aspects of the Root of Trust module to address possible compromise in a boot process, according to at least one embodiment;

FIG. 3 illustrates a sequence flow associated with an interface for a system-on-chip with a Root of Trust module to address possible compromise in a boot process, according to at least one embodiment;

FIG. 4 illustrates computer and processor aspects of a system associated an interface for a system-on-chip with a Root of Trust module to address possible compromise in a boot process, according to at least one embodiment;

FIG. 5 illustrates a process flow for a system associated with an interface for a system- on-chip with a Root of Trust module to address possible compromise in a boot process, according to at least one embodiment;

FIG. 6 illustrates yet another process flow for a system associated with an interface for a system-on-chip with a Root of Trust module to address possible compromise in a boot process, according to at least one embodiment; and

FIG. 7 illustrates a further process flow for a system associated with an interface for a system-on-chip with a Root of Trust module to address possible compromise in a boot process, according to at least one embodiment.

### DETAILED DESCRIPTION

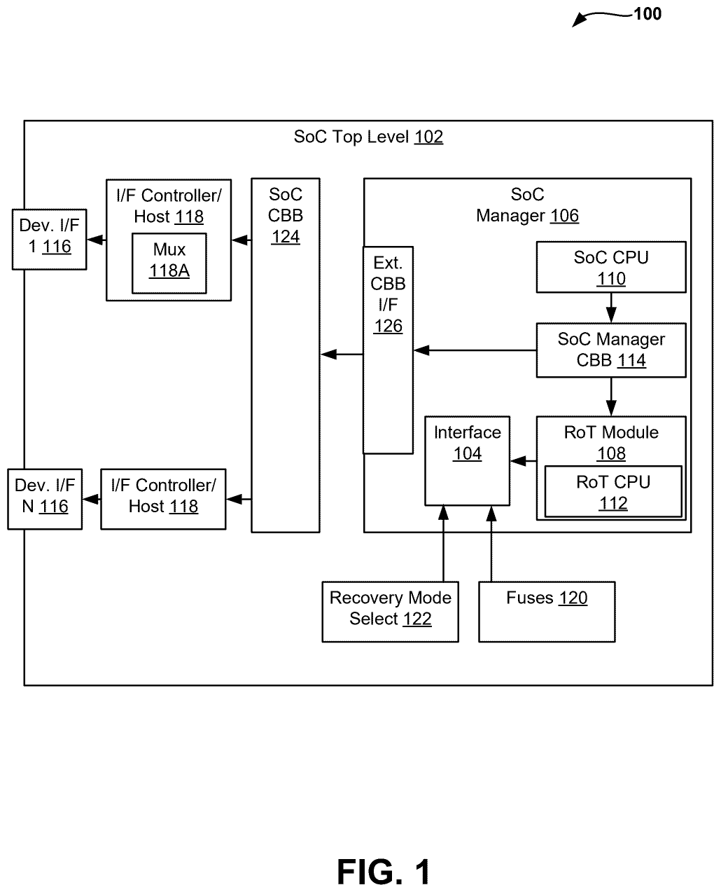

FIG. 1 illustrates a system 100 that is subject to embodiments of an interface for a system-on-chip (SoC) with a Root of Trust (RoT) module to address possible compromise in a boot process, as detailed herein. The reference to a possible compromise herein includes a possibility of compromise any part of the RoT process. The possible compromise is preempted and is addressed by the system 100 of FIG. 1. As such, none of the illustrated features are required to be compromised but are prevented from compromise by at least the interface 104 and features thereof, as used herein. The system 100 may include an SoC top level 102 that provides or includes an interface 104 to disaggregate a fetch process from a security process. The interface 104 may be also referred to herein as a boot interface or universal boot interface (UBI), unless otherwise indicated as being an interface for other purposes, including a physical device interface.

In at least one embodiment, the disaggregation of the fetch process can address a highest risk and customer-impactful trust feature but may allow such features to be booted at a later time. This guarantees first instruction integrity, as well as support to secure boot and to measured boot capabilities. Further, the interface 104 herein may be able to use a mailbox (Mbox) approach that may be a trusted cache or a buffer (also referred to herein as a SysRAM or system RAM) of a RoT module during the boot process. In at least one embodiment, nuclear keys, such as a requirement to provide multi-factor authentication to proceed in a boot process may be also enabled using the interface 104 herein.

In at least one embodiment, the interface 104 may be provided for association with an SoC manager 106 and an RoT module 108. The interface 104, in at least one embodiment, may be included in a fixed-function hardware state machine or processor that is independent of the SoC manager or the RoT module. The SoC manager and the RoT module may be associated with their own execution units or processors. Therefore, the interface 104, the SoC manager and the RoT module may be on different circuits, but at least the interface 104 is in a separate circuit than the SoC manager and the RoT module. The execution units may be on a same or different processors, such as different central processing units (CPUs). Therefore, in at least one embodiment, the interface 104 may be associated with an SoC CPU 110 of the SoC manager 106 and with an RoT CPU 112 of the RoT module 108. While, in at least one instance, the interface 104 may be described as being between the SoC CPU and an RoT CPU, it is understood that this is only a description of the interface 104 being logically able to couple between the SoC CPU 110 and the RoT CPU 112, and not as to a physical location of the interface 104.

The interface 104 may be able to determine boot media parameters of connected devices and to be connected (or expected) devices. In at least one embodiment, the interface 104 is also able to initiate First Mutable Code (FMC) fetches for one or more FMCs that are to be loaded to the RoT module. The interface 104 is also able to enforce a boot policy that may be associated with distinct security policies. Further, the boot policy may require acknowledgement and approval of at least the SoC manager and the RoT module to continue a boot process till the SoC manager or other firmware or devices can take over. Therefore, the interface 104 is a universal boot interface (UBI) that can logically sit between an SoC manager and a RoT module and that allows determination of boot media parameters of connected and expected devices for a system that includes the interface 104.

In at least one embodiment, the interface 104 can initiate FMC fetches for the one or more FMCs that are to be loaded to the SysRAM of the RoT module and can enforce the boot policy. While the boot policy may require acknowledgement and approval of at least the SoC manager and the RoT module to continue a boot process, the security issues and manageability issues may be addressed as the interface is a lightweight interface that does not allow loading of the RTM and RTV features till the SoC manager or other system component can take over.

In at least one embodiment, however, the acknowledgement and approval may be to one or more external devices that may interface with the system, as well as of the SoC manager and the RoT module. As the interface 104 may, in at least one instance, only enforce a boot policy against limited components, it may be considered lightweight and less open to compromise relative to an SoC manager that may otherwise control the boot process. Further, the interface 104 may allow one or more of the SoC manager or the RoT module to access contents of a mailbox of the RoT module. The contents can include the at least one FMC fetched by the interface 104, which can be used to enable one or more of the SoC manager or the RoT module to enact a respective security policy and to set a handshake that confirms presence of firmware to continue the boot process. Thereafter, the interface 104 allows the SoC manager to copy the firmware to a storage of the SoC manager and the firmware enables the SoC manager or other firmware or devices to continue the boot process.

In at least one embodiment, the interface 104 allows for RoT measurement requirements to be performed. The measurement may be in reference to a confirmation that an attester's device configuration is as intend—such as, by measuring and controlling changes to non-volatile configuration bits associated with the device and provided by a manufacturer (for instance), and then reporting that as measurement. The measurement may be applied to binaries of the FMC, for instance.

In at least one embodiment, the properties of the interface 104 herein include an ability to perform locking when the RTM or RTV features of the boot process requires exclusive access to the interface 104. This is to ensure that no other agent fetches the FMC first. In at least one embodiment, a further property of the interface 104 is to provide muxing (or multiplexing), which is a reference to the ability of the interface 104 to control a multiplexer (MUX) 118A to select for input/out (I/O) controllers associated with device interface 116 of the system 100. In at least one embodiment, these I/O controllers may be between the system 100 and a management controller.

In at least one embodiment, yet another property of the interface is immutability. That is, the interface 104 and its I/O controller dependencies strive to be immutable logic. While full immutability with I/O may be an issue, at least because some of such properties may change post-silicon (such as, changes to drive strengths, frequencies, and dummy cycles), the controllers at issue herein may be permitted to have a patchability. Patchability may be provided via e-fuses (or fuses) 120. In at least one embodiment, however, patchability may use a patch logic that may be provided in a manner that may not be able to affect a device's configuration beyond the controllers at issues. The interface 104 also offers I/O controller configurability in the event that RTM or RTV needs it. In at least one embodiment, the interface 104 herein may be a producer and/or consumer model. As such, the RTM/RTV features may issue requests to the interface 104. The interface 104 may translate these requests to requests to the I/O controller. However, the I/O controller need not make requests in turn, such as, for a serial peripheral interface (SPI). For recovery that may be associated with an Open Compute Protocol (OCP) and that may involve SMBus, I3C target, USB2 device endpoint, etc., there may be further I/O requests made.

In at least one embodiment, the interface 104 herein can also address issues of an SoC manager initiating from reset first and, along with the RoT module, that controls the boot process, which opens the RoT to compromise. As the RoT module authenticates itself followed by the connected and expected devices, there may be security issues of compromise of the RoT module. For example, the SoC manager, via an SoC FMC, may form a chain of trust based on information from the RoT module. However, to the extent that the SoC manager is compromised, then multiple features (firmware or software components, including those pertaining to the RTM and RTV) of the boot process may be also compromised. Further aspects compromised may include a reporting feature, a recovery feature, storage features, fuses, firmware, transfer features, debug features, I/O encryption features, and identity features. In contrast, compromising the interface 104 herein may only compromise an initial measurement of the system 100.

In at least one embodiment, the RTM may imply exclusive access to boot media I/O. As such, by addressing possibilities of compromise of the RTM, the interface 104 can also prevent improper access to the boot media I/O. Further, the interface 104 can also address SPI integration issues, which may be problematic for physical design at least because the RoT module may be given to assume that the SPI controller is on local fabric (such as, an Advanced High-Performance Bus (AHB)). The fabric can also assume a shared clock and fixed latency that may not be subject to retiming. However, the boot media parameters received to the interface may also include a clock rate that may be from provided e-fuses (also referred to herein as fuses) 120. For example, if there is no firmware or boot code available to the interface 104, one fuse 122 may include a hardcoded clock rate to be used.

In at least one embodiment, therefore, as to the boot media parameters, when it is determined by the interface 104 that no devices are connected or that a connected or expected device was not able to find its own boot code or firmware to run, the recovery mode select 122 may be used to provide boot code or firmware for at least expected devices. With respect to the fuses 120, as there may not be firmware loaded, the interface 104 can query the fuses 120 as to a clock rate to use. At least one the fuses 120 may include a clock rate that is hard-coded, such as a 20 megahertz clock to operate a bus, such as one of the control backbone buses (CBBs) 114, 124, 126. The fuse may be a non-volatile memory component, in one example. Therefore, at least a clock may be associated with the interface 104 and may be determined, in part, from the boot media parameters and using a fuse 120 that is a hardware feature of the system 100.

Therefore, the boot media parameters may also include device configuration associated with a connected or expected device. In at least one embodiment, each connected or expected device may include its own boot code or firmware, which can be used to initiate each of the device interfaces 116, through the interface 104 as part of the boot process. The boot code or firmware may be provided through their respective host or controller 118. Further, a recovery mode select 122 feature that is associated with the interface 104 allows the interface to receive boot media parameters of connected or expected devices that could not provide its own boot code or firmware.

In at least one embodiment, a serial peripheral interface (SPI) feature of the system 10 may include a fixed latency and may include a pad that may need to be on a pad ring. The pad ring may be in reference to rings that may include power and ground lines, as well as I/O pads and protection structures, on a silicon version of the SoC top level 102. The RoT module may be required to be next to pad ring but may also need to be co-located with SoC manager. Therefore, although illustrated as blocks in the SoC lop level 102 illustration of FIG. 1, these blocks provide only logical boundaries, and not necessarily physical boundaries, to the illustrated features. However, using the interface 104 to address part of the boot process also allows variation of the physical boundaries of one or more of the illustrated features, even if the RoT module is required to be co-located with the SoC manager, for instance. As such, it is possible to simplify the unit verification of the SoC lop level 102 using the interface 104 and it is also possible to provide locality benefits from existing security sensors using the interface 104.

In at least one embodiment, while addition of an I3C® bus and universal asynchronous receiver-transmitter (UART®) in the SoC lop level 102 may be subject to issues as certain pads may already be shared with other controllers, the provision of the interface 104 provides flexibility to also address this issue. Still further, part of an RTM complexity addressed herein may be by using an interface 104 for at least part of the boot process, so that the interface 104 allows for interface independence for a flashless boot processes that may not otherwise align with standards on I3C, USB2®, and eSPI®. In addition, while I/O connectivity may imply a full-chip verification being in place, which may be a cost hurdle, the use of the interface 104 can simplify the verification. This is also while maintaining capability in the system 100 for newer interconnect standards, including Universal Chiplet Interconnect Express (UCIe).

In at least one embodiment, in FIG. 1, the interface 104 is able to initiate FMC fetches for connected and expected devices, including for device interfaces (dev. I/Fs 1-N) 116. The device interfaces 116 may include two-wire interfaces and SPIs. Further, there may be controllers or hosts 118 to provide firmware or boot code (or FMC) to the interface 104, as required during the boot process. In at least one embodiment, one or more of the internal device interfaces (I/Fs) 114, 124, 126 illustrated in FIG. 1 may be for a SoC top level 102 and may be CBBs. A CBB may be a parallel interface to transfer data between the SoC features illustrated, such as the SoC CPU 110, the RoT module 108, and the various hosts or controllers 118. In at least one embodiment, a CBB may include data lines that are bonded. The CBB can reduce on time and boot-up time of the of the SoC features through the bus parallelization, while avoiding any overhead from high-frequency serial interfaces. In at least one embodiment, therefore, FIG. 1 illustrates that the interface 104 may be included in a fixed-function hardware state machine or processor that is independent of processors (such as the SoC CPU 110 and the RoT CPU 112) associated with one or more of the SoC manager or the RoT module.

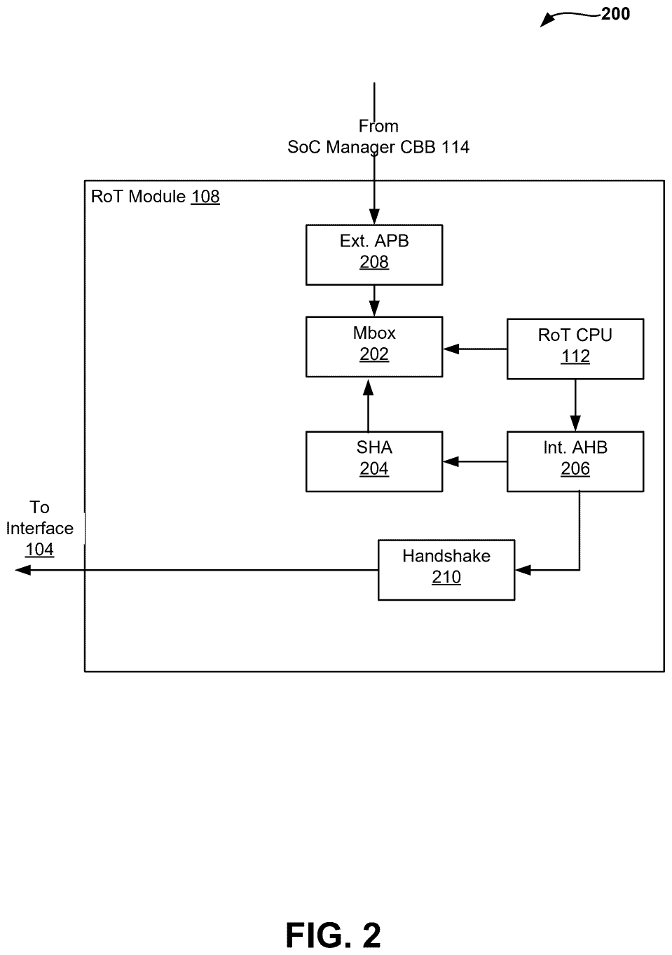

FIG. 2 illustrates aspects 200 of the RoT module 108 to address possible compromise in a boot process, according to at least one embodiment. Other than illustrated in FIG. 1, the RoT module 108 may further include a single RoT mailbox (Mbox) 202, a secure hash algorithm (SHA) or other cryptography engine 204, and a handshake feature 210. There may be an advanced peripheral bus (APB) 208 and an advanced high-performance bus (AHB) 206 for on-chip communication in the RoT module 108.

The Mbox 202 is to receive, retain, and support copying therefrom of firmware or boot code provided by each connected or expected device. For example, a firmware may be signed at some earlier point. The RoT module 108, via its CPU 112, can authenticate that firmware based in part on the signature of the firmware. Differently, the measurements for the RoT module 108 are collected at a boot time itself. For example, the measurements may be a SHA 384 or other hash (from a SHA engine 204) of the firmware's binary. The RoT module 108 can use a private key to sign and prepare a report of all the measurements of the firmware received to its Mbox 202 and that it has executed.

In at least one embodiment, a report may be generated for all the measurements of all the firmware executed. Further, a different party that needs to use a connected and loaded device can read the report because it trusts the key from the RoT module 108. In this manner, any of the other SoC features illustrated in FIG. 1 and the external devices or software using the boot process can use the devices that are trusted by the RoT module 108. In at least one embodiment, therefore, the interface 104 includes a reporting feature to sign measurements associated with an attester's configuration for its device. The interface 104 may also include a storage feature to hold the measurements, as well as an identity feature to issue and endorse identifies of an attester in the system 100.

In at least one embodiment, the firmware that is copied into the Mbox 202 is subject to a boot policy of the RoT module 108. For example, the boot policy may be to measure the firmware and to prepare a report, followed by an acknowledgement and approval to proceed with the boot process. Therefore, the boot media parameters can be determined based in part on detected ones of the connected and the expected devices from a recovery mode select feature of the system. Such an acknowledgement and approval may be provided using the handshake feature 210. In at least one embodiment, the handshake feature 210 may be a setting in a state machine, with a state set that corresponds to the acknowledgement and approval of a firmware. The boot policy, therefore, requires acknowledgement and approval of at least the SoC manager and the RoT module, as these aspects provide their firmware separately, to be trusted and to continue a boot process.

In at least one embodiment, a Secure Hash Algorithm (SHA) engine 204 may be used to compute a hash for each firmware or for contents of the Mbox 202. The system herein is able to store the hash in a secure element that may or may be part of the Mbox 202. In at least one embodiment, the boot policy may include the need to compute a hash as well as part of the measurement requirement in the RoT module 108. The SoC CPU 110 is able to request functions of the RoT module 108. For example, a part of the boot policy, enforcement may require the SoC CPU 110 to perform authentication of the firmware, in addition to the measurements of the loaded firmware performed by the RoT module 108. The SoC CPU 110 can read the firmware from the Mbox 202, along with the signature, and can compute a signature of its own to compare with the signature of the RoT module 108. Then, the SoC CPU 110 can inform the interface 104 of the authentication by setting a handshake or other state machine, for instance. Therefore, the SoC manager 106, as well as the RoT module 104, can be caused to perform trust actions by the interface 104.

In at least one embodiment, if the authentication fails, then the boot policy may be violated and the acknowledgement and approval of at least the SoC manager and the RoT module may not be set to continue a boot process. A failsafe operation, such as a reset of the system 100 may be performed as a result. In at least one embodiment, to the extent that the authentication and the measurements are both complete, and the boot policy that requires acknowledgement and approval of at least the SoC manager and the RoT module are satisfied, then the interface 104 can allow further access to its Mbox 202 and can allow bypass of the interface 104 to perform further boot processes.

In at least one embodiment, the further boot processes may be performed by either the interface 104 or by the SoC manager 106, via the SoC CPU 110. In at least one embodiment, the connected or expected devices, the SoC manager, and the RoT module may provide its firmware in any order for authentication and for measurements performed in the RoT module 108 and by the SoC CPU 110. The bypass of the interface 104, after the acknowledgement and approval, allows the SoC CPU 110 to talk directly to one or more hosts or controllers 118.

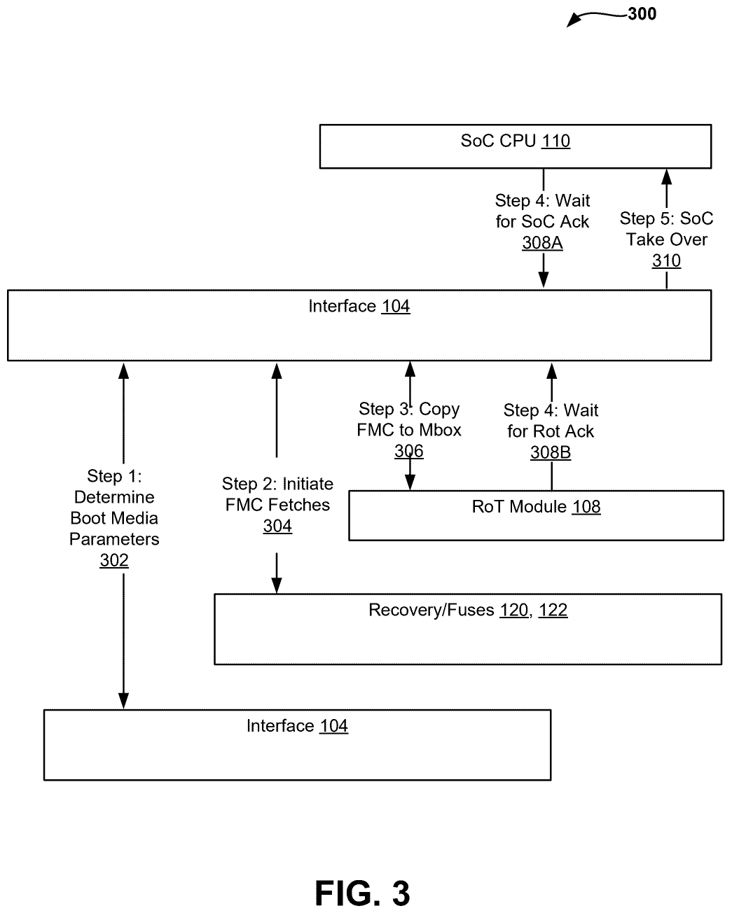

FIG. 3 illustrates a sequence flow 300 for a system-on-chip with a Root of Trust module to address possible compromise in a boot process, according to at least one embodiment. As illustrated, the interface 104 may reset, initiate, or start. The interface 104 may read or determine 302 the boot media parameters. The boot media parameters may be received in the interface 104 and may be used by the interface 104 to initiate or perform 304 FMC fetches for at least one FMC. The at least one FMC is to be loaded to the RoT module, such as, by copying 306 it to the Mbox 202. In at least one embodiment, the FMC may be the firmware or boot code referenced throughout herein. The RoT module (and particularly the RoT CPU) and the SoC CPU may then be in a spin loop while waiting for an interrupt from the interface 104. The interrupt may occur to indicated to the CPUs 110, 112 that the firmware is loaded into the Mbox 202.

In at least one embodiment, the CPUs 110, 112 may then process the contents of the Mbox 202 to enact their respective security policies, which may be part of the boot policy enforced by the interface 104. The security policies may correspond to the authentication and the measurements discussed with respect to at least FIG. 2 herein. Once the security policies are verified and completed, acknowledgement 308A, 308B and approval from the CPUs 110, 112 may be provided by setting of the handshakes. In at least one embodiment, this represents allowing one or more of the SoC manager or the RoT module to access contents of a Mbox 202 of the RoT module. Those contents may include at least one FMC and the at least one FMC may enable one or more of the SoC manager or the RoT module to enact a respective security policy and to set a handshake that confirms presence of firmware to continue the boot process. The setting of the handshake indicates to the interface 104 to proceed with the boot process for other devices. However, the interface 104 can allow itself to be bypassed so that the SoC manager, via the SoC CPU 110 can take over 310 to boot other devices.

In at least one embodiment, the SoC manager can copy over the firmware that it needs to continue the boot process. Further, the boot policy may include allowing such an action as copying the firmware out of the Mbox 202 into a memory controlled by the SoC CPU 110. In at least one embodiment, this represents allowing the SoC manager to copy the firmware to a storage of the SoC manager. The firmware enables the SoC manager to continue the boot process. For example, the SoC CPU 110 can perform authenticating of that firmware, as well as measurements, decryptions, and execution of the firmware to allow use of the underlying device.

In at least one embodiment, the firmware loaded may be an initial firmware that is other than the SoC CPU and the RoT module and that may itself take control of the boot process to cause (such as, program) the interface 104 to fetch the next firmware of a next device to be loaded. In at least one embodiment, with respect to the next firmware, the initial firmware and the next firmware may perform the same copying over to the Mbox 202, the authentication and/or measurements, and the handshake aspects using the interface 104. In this manner, as each firmware is valid and is loaded, a chain of trust is established for all loaded firmware.

In at least one embodiment, these handshakes and loading of firmware may continue till a point where a runtime firmware is available and then the runtime firmware may use the interface 104 for other purposes. In at least one embodiment, booting off of the SMbus may be performed but may not be handled by the interface 104. As such, the interface 104 may be bypassed so that aspects of power management and its underlying firmware may be loaded by the SoC CPU 110, instead.

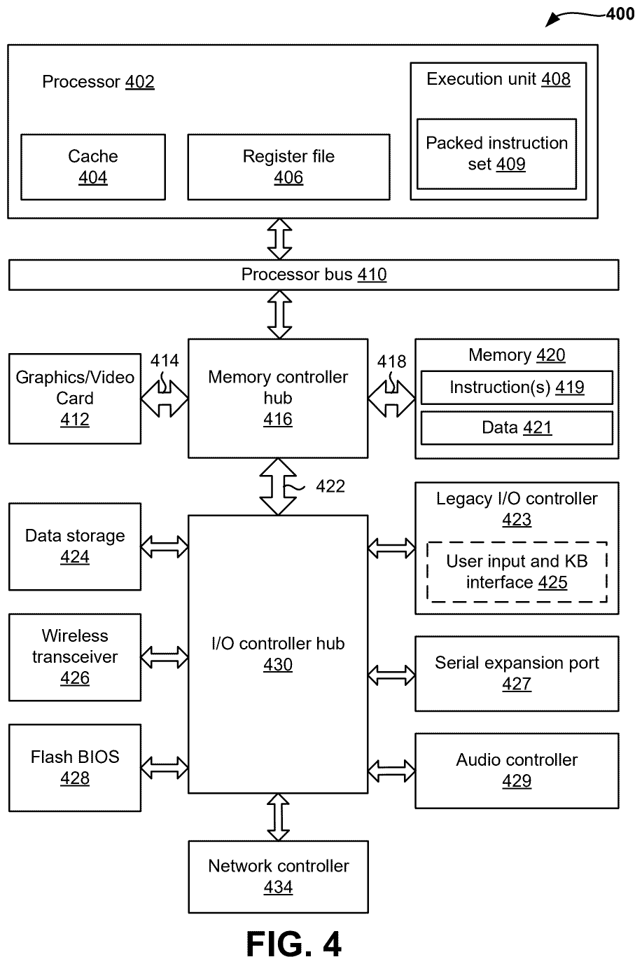

FIG. 4 illustrates computer and processor aspects of a system associated an interface for a system-on-chip with a Root of Trust module to address possible compromise in a boot process, according to at least one embodiment. For example, one or more processors 402 may include one or more processing or execution units 408 that can perform all or some aspects of the CPU 110, 112 that is associated with the SoC Manager, the RoT module, and the interface herein. In at least one embodiment, all or some aspects of the SoC Manager, the RoT module, and the interface may be performed on distinct microcontrollers that are all distinct circuits and that are all associated with the processor 402 of the system 400.

The one or more execution units 408 may include circuits to support an interface that is associated with a SoC manager and with an RoT module. The interface is to receive boot media parameters of connected and expected devices. The interface may be able to initiate FMC fetches that are to be loaded to the RoT module. The interface may be further to enforce a boot policy that requires acknowledgement and approval of at least the SoC manager and the RoT module to continue a boot process. Therefore, it is possible to copy at least one FMC, from the FMC fetches performed, to the Mbox 202 of the RoT module. The interface 104 can then wait for the RoT module to acknowledge the at least one FMC, which makes the FMC an attested copy.

The computer and processor aspects 400 may be performed by one or more processors 402 that may represent one or more of the CPUs 110, 112, and a further processor of the interface 104. The processors 402 may include the system-on-chip (SOC) or some combination thereof formed with a processor that may include execution units to execute an instruction, according to at least one embodiment. In at least one embodiment, the computer and processor aspects 400 may include, without limitation, a component, such as a processor 402 to employ execution units 408 including logic to perform algorithms for process data, in accordance with present disclosure, such as in embodiment described herein.

In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in computer and processor aspects 400.

In at least one embodiment, a processor 402 may include, without limitation, a Level 1(“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data, and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

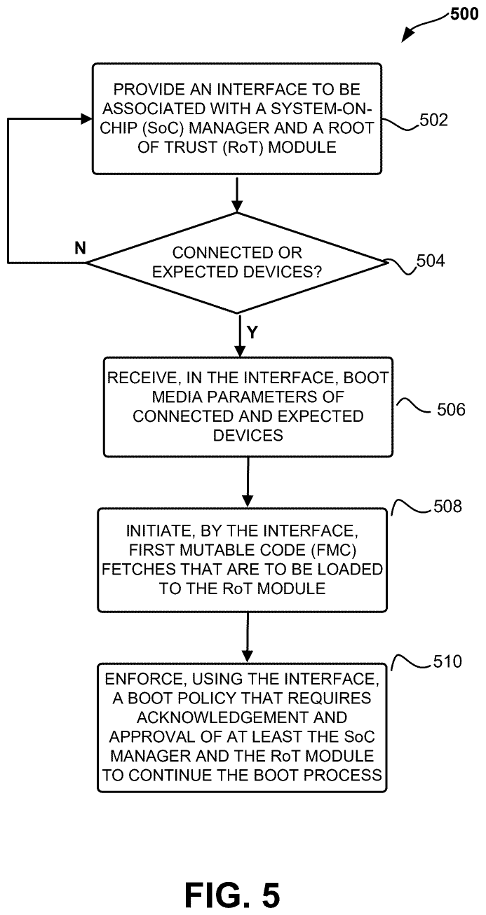

FIG. 5 illustrates a process flow or method 500 for a system associated with an interface for a system-on-chip with a Root of Trust module to address possible compromise in a boot process, according to at least one embodiment. The method 500 may include providing 502 an interface to be associated with a system-on-chip (SoC) manager and a root of trust (RoT) module. The method 500 may include determining 504 that there are connected or expected devices. For example, the determining 504 step may be performed by polling or being ready to receive boot media parameters associated with the connected or expected devices. In at least one embodiment, the method 500 may include receiving 506, in the interface, boot media parameters of connected and expected devices. The method 500 may include initiating 508, by the interface, First Mutable Code (FMC) fetches that are to be loaded to the RoT module. Further, the method 500 may include enforcing 510, using the interface, a boot policy that requires acknowledgement and approval of at least the SoC manager and the RoT module to continue the boot process. For example, the enforcing 510 may be performed by requiring the handshake for each of the SoC manager and the RoT module after their authentication and measurements are completed.

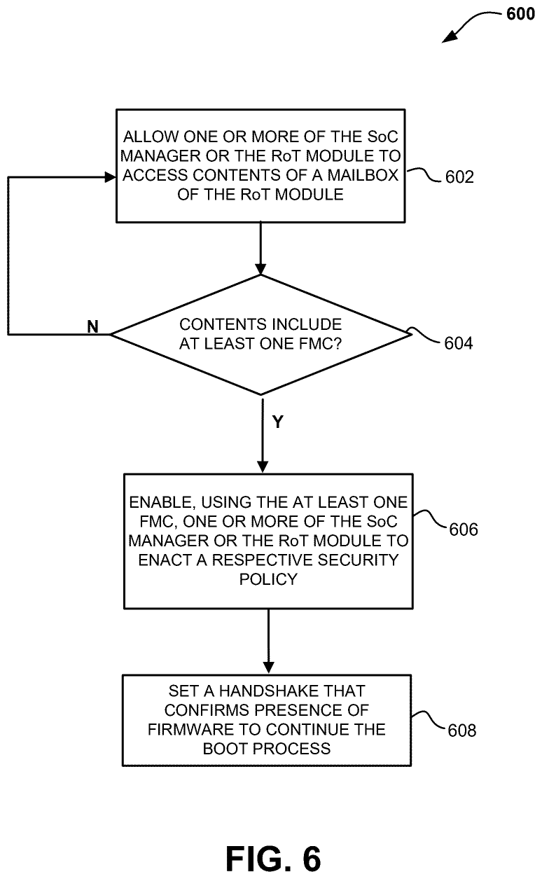

FIG. 6 illustrates yet another process flow or method 600 for a system associated with an interface for a system-on-chip with a Root of Trust module to address possible compromise in a boot process, according to at least one embodiment. In at least one embodiment, this further method 600 may support the method 500 in FIG. 5. This further method 600 may include allowing 602 one or more of the SoC manager or the RoT module to access contents of a mailbox or Mbox of the RoT module. When the contents are verified 604 as including at least an FCM, the method 600 may include enabling 606, using the at least one FMC, one or more of the SoC manager or the RoT module to enact a respective security policy. The method 600 may include, further, to set 608 a handshake that confirms presence of firmware to continue the boot process. The setting step 608 may be performed separately by the SoC manager and the RoT module. In at least one embodiment, the steps in this further method 600 may be part of the acknowledgement and approval of step 510 in the method 500 of FIG. 5.

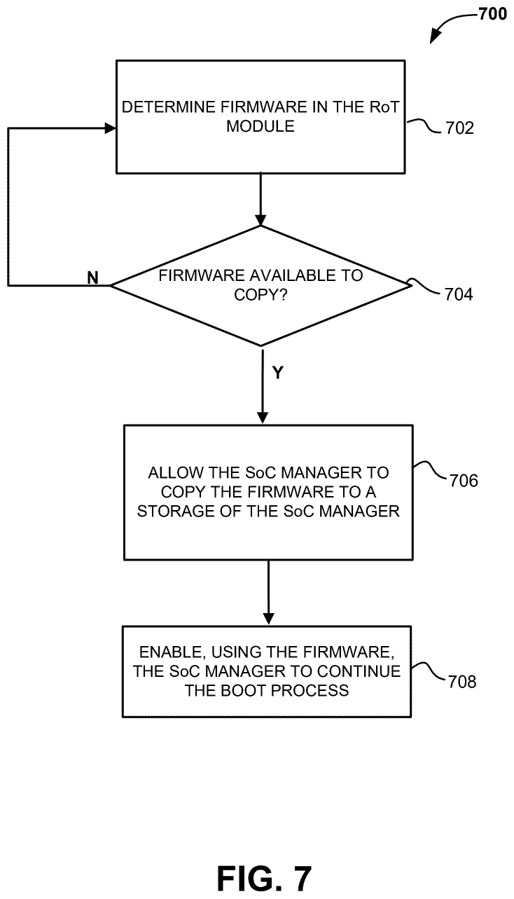

FIG. 7 illustrates a further process flow or method 700 for a system associated with an interface for a system-on-chip with a Root of Trust module to address possible compromise in a boot process, according to at least one embodiment. In at least one embodiment, this further method 700 may also support one or more of the methods 500; 600 in FIG. 5 or 6. This further method 700 may include determining 702 FMC, such as firmware or boot code, in the RoT module. The method 700 may include verifying 704 that the firmware is available to copy. The method 700 may include allowing 706 the SoC manager to copy the firmware to a storage of the SoC manager. Further, the method 700 may include enabling 708 the SoC manager to continue the boot process using the firmware, which enables the chain of trust use of the systems herein.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. An interface provided on at least one circuit to initiate First Mutable Code (FMC) fetches that are loaded to a Root of Trust (RoT) module and to enforce a boot policy that requires acknowledgement and approval of at least a system-on-chip (SoC) manager and the RoT module to continue a boot process.

2. The interface of claim 1, wherein the interface is comprised in a fixed-function hardware state machine or processor of the at least one circuit that is independent of further circuits comprising a plurality of processors associated with one or more of the SoC manager or the RoT module.

3. The interface of claim 1, further comprising a reporting feature to sign measurements associated with an attester's configuration, a storage feature to hold the measurements, and an identity feature to issue and endorse identifies of an attester in the system.

4. The interface of claim 1, wherein the boot media parameters are determined based in part on detected ones of the connected and the expected devices from a recovery mode select feature of the system.

5. The interface of claim 1, wherein at least a clock to be associated with the interface is determined, in part, from the boot media parameters and using a fuse hardware feature of the system.

6. The interface of claim 1, wherein the interface is further to copy at least one FMC, from the FMC fetches performed, to a mailbox of the RoT module, and is to wait for the RoT module to acknowledge the at least one FMC as an attested copy.

7. The interface of claim 1, wherein the interface is further to:
allow one or more of the SoC manager or the RoT module to access contents of a mailbox of the RoT module, wherein the contents comprise at least one FMC, and wherein the at least one FMC enables one or more of the SoC manager or the RoT module to enact a respective security policy and to set a handshake that confirms presence of firmware to continue the boot process.

8. The interface of claim 7, wherein the interface is further to:
allow the SoC manager to copy the firmware to a storage of the SoC manager, wherein the firmware enables the SoC manager to continue the boot process.

9. A system comprising:
a system-on-chip (SoC) manager, a root of trust (RoT) module, and an interface associated therewith, wherein the interface is to receive boot media parameters of connected and expected devices in the system, to initiate First Mutable Code (FMC) fetches that are loaded to the RoT module, and to enforce a boot policy that requires acknowledgement and approval of at least the SoC manager and the RoT module to continue a boot process.

10. The system of claim 9, wherein the interface is comprised in a fixed-function hardware state machine or processor of the plurality of circuits, and wherein the plurality of circuits comprise independent processors associated with one or more of the SoC manager or the RoT module.

11. The system of claim 9, further comprising a reporting feature to sign measurements associated with an attester's configuration, a storage feature to hold the measurements, and an identity feature to issue and endorse identifies of an attester in the system.

12. The system of claim 9, wherein the boot media parameters are determined based in part on detected ones of the connected and expected devices from a recovery mode select feature of the system.

13. The system of claim 9, wherein at least a clock to be associated with the interface is determined, in part, from the boot media parameters and using a fuse hardware feature of the system.

14. The system of claim 9, wherein the interface is further to copy at least one FMC, from the FMC fetches performed, to a mailbox of the RoT module, and is to wait for the RoT module to acknowledge the at least one FMC as an attested copy.

15. A system comprising:
at least one circuit to perform a boot process with at least one interface that receives boot media parameters of connected and expected devices, initiates First Mutable Code (FMC) fetches that are loaded to the RoT module, and that enforces a boot policy that requires acknowledgement and approval of at least the SoC manager and the RoT module to continue the boot process.

16. The system of claim 15, wherein the at least one circuit is further to:
allow one or more of the SoC manager or the RoT module to access contents of a mailbox of the RoT module, wherein the contents comprise at least one FMC, and wherein the at least one FMC enables one or more of the SoC manager or the RoT module to enact a respective security policy and to set a handshake that confirms presence of firmware to continue the boot process.

17. The system of claim 15, wherein the at least one circuit is further to:
allow the SoC manager to copy the firmware to a storage of the SoC manager, wherein the firmware enables the SoC manager to continue the boot process.

18. A method for a boot process, comprising:
receiving, in an interface associated with a system-on-chip (SoC) manager and a root of trust (RoT) module, boot media parameters of connected and expected devices;
initiating, by the interface, First Mutable Code (FMC) fetches that are loaded to the RoT module; and
enforcing, using the interface, a boot policy that requires acknowledgement and approval of at least the SoC manager and the RoT module to continue the boot process.

19. The method of claim 18, further comprising:
allowing one or more of the SoC manager or the RoT module to access contents of a mailbox of the RoT module, wherein the contents comprise at least one FMC; and
enabling, using the at least one FMC, one or more of the SoC manager or the RoT module to enact a respective security policy and to set a handshake that confirms presence of firmware to continue the boot process.

20. The method of claim 18, further comprising:
allowing the SoC manager to copy the firmware to a storage of the SoC manager, wherein the firmware enables the SoC manager to continue the boot process.
